(19) United States
(12) Patent Application Publication
(10) Pub. No.: US 2008/0279454 A1
(43) Pub. Date: Nov. 13, 2008

(54) SLOT IN HOUSING ADAPTED TO RECEIVE AT LEAST A PORTION OF A PRINTED PAPER ITEM FOR OPTICAL CHARACTER RECOGNITION

(76) Inventors: Jeffrey A. Lev, Cypress, TX (US); Richard E. Hodges, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/745,259

(22) Filed: May 7, 2007

(51) Int. Cl. G06K 9/00; G06F 3/02; H04N 5/225

(52) U.S. Cl. 382/181; 345/168; 348/373; 348/E05.026

(57) ABSTRACT

A system, comprising a camera and a housing comprising a slot. The slot is adapted to receive at least a portion of a printed paper item, an image of which is acquired by the camera. The system also comprises logic that performs optical character recognition on the image.

### BACKGROUND

It is common-place for people to exchange business cards. Managing the information on business cards one receives from other people can be tedious. One might attempt to manually enter the information from business cards (e.g., name, phone number, etc.) into a database of such information. This manual data-entry process can be time consuming and tedious.

### BRIEF DESCRIPTION OF THE DRAWINGS

For a detailed description of exemplary embodiments of the invention, reference will now be made to the accompanying drawings in which:

FIG. 1 shows a system comprising a slot for a printed paper item in accordance with various embodiments;

FIG. 2 shows the system of FIG. 1 in which a printed paper item has been inserted into the slot;

FIG. 3 shows a side view of the system in which the display lid has been partially lowered to acquire an image of the printed paper item in accordance with various embodiments;

FIG. 4 shows detail of the slot in which the printed paper item is inserted in accordance with various embodiments;

FIG. 5 shows a block diagram of the system of FIG. 1 in accordance with various embodiments; and

FIG. 6 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

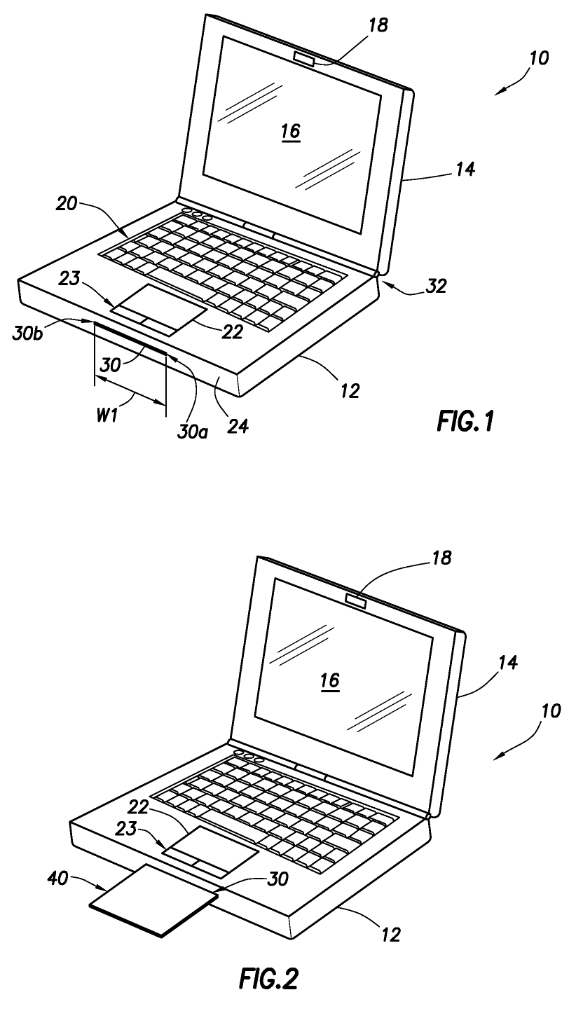

Referring to FIG. 1, a system 10 is shown in accordance with various embodiments. As shown, system 10 comprises a portable computer, but may comprise other types of electronic devices in other embodiments. In the embodiment shown in FIG. 1, system 10 comprises a display lid 14 coupled via a hinge 32 to a keyboard housing 12. The display lid 14 comprises a display 16 and a camera 18 mounted in an upper area of the display lid 14. By action of the hinge 32 that couples together the display lid 14 and housing 12, a user can open and close the display lid 14.

The housing 12 comprises an input device 20, such as a keyboard. The housing 12 also comprises a touch pad 32 and one or more selection devices (e.g., buttons). The housing 12 comprises a front surface 24 that faces a user when the user is seated in front of the system 10.

In accordance with various embodiments, the front surface 24 comprises a slot 30 into which a printed paper item can be inserted by a user. FIG. 2 shows an example in which a printed paper item 40 has been inserted into the slot 30. In accordance with at least some embodiments, at least some, but not necessarily all, of the printed paper item 40 is inserted into the slot 30. As such, in accordance with some embodiments, at least some of the printed paper item 40 projects out from the front surface 24 of the housing 12. Thus, in this disclosure, references to the insertion of the printed paper item 40 into the housing's slot 30 does not necessarily mean that the slot receives the entirety of the printed paper item.

In accordance with various embodiments, the printed paper item 40 may comprise a business card or other type of printed item comprising information that the user wishes to have stored on or by system 10. Once the printed paper item 40 is at least partially inserted into slot 30 in the front surface 24 of the housing 12, the user partially lowers the display lid 14 towards a closed position to thereby enable camera 18 to acquire an image of the text on the printed paper item 40. In various embodiments, the display lid 14 need is not completely closed to acquire the image. Once the camera 18 has acquired the image of the text on the printed paper item 40, logic in the system 10 performs optical character recognition on the acquired image to obtain information such as a person's name, organization name, telephone number, email address, mailing address, etc. from the printed paper item 40. Some or all of such information is then stored in a database which, for example, may be internal to the system 10. An example of such a database comprises a “contacts” database such as is provided in various email programs.

FIG. 3 shows a side view of system 10 in which the display lid 14 has been partially closed to thereby enable camera 18 to acquire an image of the text provided on the printed paper item 40. FIG. 3 thus illustrates the image capture position for display lid 14. As shown, the display 14 is coupled to the housing 12 via the hinge 32. The hinge 32 posses sufficient frictional force to enable the display lid 14 to remain in any position between the fully open position and a fully closed position as desired by the user. Accordingly, when a user desires to perform an optical character recognition process on a printed paper item 40, the user activates (e.g., using touch pad 22 and a selection device 23) an application (discussed below) on system 10. The system 10 then prompts the user to insert the printed paper item 40 into the slot 30 and then to gradually lower the display lid 14. In other embodiments, the user inserts the printed paper item 40 into slot 30 before activating the application.

In accordance with various embodiments, camera 18 is capable of performing an auto-focus process. Once the user begins lowering the display lid 14, the camera begins to achieve auto-focus on the printed paper item 40. The camera 18 and slot 30 are positioned in system 10 such that as the display lid 14 is lowered, the camera 18 faces the printed paper item as indicated by arrow 21 in FIG. 3. As the user lowers the display lid 14, the camera 18 eventually achieves auto-focus. Auto-focus can be achieved even though the center axis of the camera 18 (represented by arrow 21 and an axis through printed paper item 40 and perpendicular to the plane of the printed paper time are at an angle 0 to each other. In at least some embodiments, auto-focus is achievable for any angle Θ from about 0° to 35°.

When lowering the display lid 14 towards the closed position, the camera 18 eventually will achieve auto-focus. Because the display lid 14 has been partially closed, it may not be readily easy or even possible for the user to view the display 16 in the display lid 14 while lowering the lid 14. For this reason, an indicator 25 is provided on a top surface 26 of the display lid 14 to provide feed back to the user when the camera 18 has achieved auto-focus. In some embodiments, the indicator 25 comprises a light emitting diode (LED), while in other embodiments the indicator 25 may comprise a visual indicator other than a LED. In yet other embodiments, the indicator 25 may comprise an audible indicator. Once auto-focus is achieved, logic internal to the system 10 illuminates the indicator 25. The indicator 25 indicates to the user that the camera 18 has achieved auto-focus and thus that the user should leave the display lid 14 at the location at which the auto-focus was achieved.

Once the user has lowered the display lid 14 to the point in which the camera 18 has achieved auto-focus, the camera 18 acquires an image of the printed paper item 40. In some embodiments, the camera 18 automatically acquires the image (i.e., the user need not manually force the image acquisition to occur). An optical character recognition process is then performed on the image with the resulting data being stored in a database as discussed above.

In various embodiments, camera 18 comprises a digital camera. In such embodiments, the system 10 produces an audible noise to simulate the noise produced by an analog camera taking a picture. In other embodiments, other types of user feedback is provided to indicate to the user when the image has been acquired.

If desired, a user may remove the printed paper item 40 from slot 30 and insert another printed paper item 40 into the slot. The auto-focus mechanism within system 10 detects a lack of focus when the user is removing the printed paper item 40 and inserting a new printed paper item 40. Once the auto-focus mechanism achieves auto-focus yet again, the system 10 acquires an image of the newly inserted printed paper item 40 and performs the optical character recognition and storage process again. In this way, the user can perform optical character recognition on one or more paper printed paper items as desired. Once imaging, optical character recognition and data storage of the printed paper items 40 have been completed, the user can close the display lid 14 or rotate the display lid 14 back to its fully opened position to continue using the system 10 in accordance with the desires of the user.

Referring again to FIG. 1, the width W1 of slot 30 is wide enough to accommodate a range of widths of printed paper items 40. As such, the width W1 of slot 30 may be wider than the width of a printed paper item inserted into the slot. When a user inserts a printed paper item into slot 30 the user also slides the printed paper item in slot 30 towards the right end 30a of slot 30. That is, printed paper items are right-justified when inserted into the slot 30. In other embodiments, the paper printed items 40 may be slid to the left towards end 30b of slot 30 to thereby left-justify the printed paper items. By having the user left or right justify the printed paper item 40, the printed paper item generally becomes centered under camera 18 when the display lid 14 is lowered towards the image acquisition position.

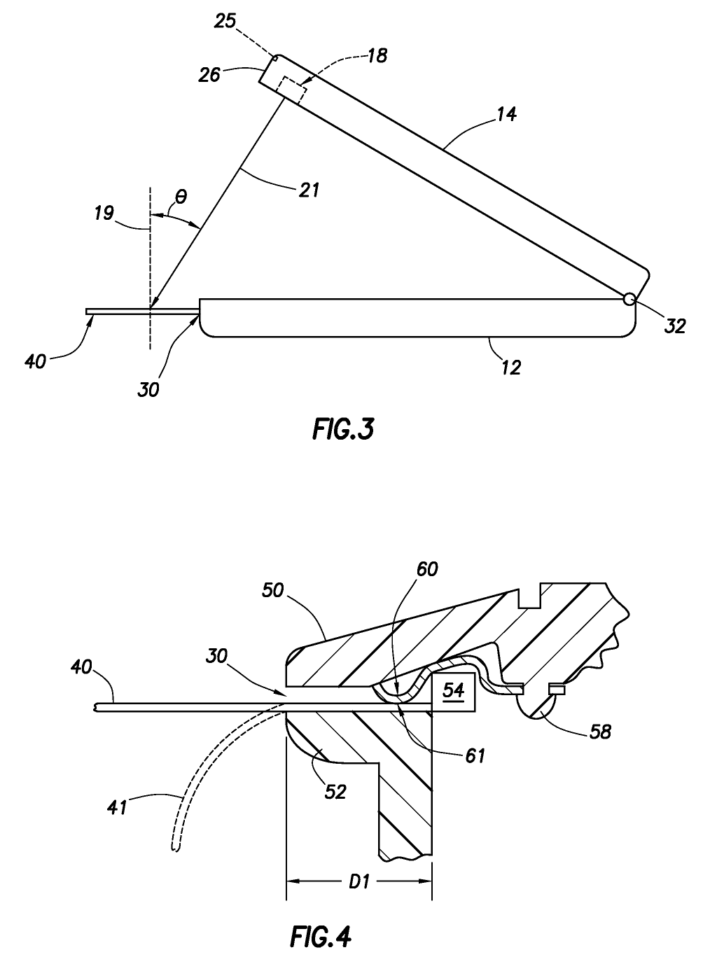

FIG. 4 shows a detailed view of slot 30 in which a printed paper item 40 has been inserted. In the embodiments shown, slot 30 is formed from two members 50 and 52. The depth D1 of the slot is defined by stop member 54. The depth D1 of the slot in some embodiments comprises a depth just sufficient to hold the printed paper item 40 in a rigid or semi-rigid position without the printed paper item 40 flopping downward as indicated by dashed lines 41. In some embodiments, D1 comprises a depth from about 2 millimeters (mm) to about 4 mm, and in various embodiments comprises about 3 mm. In some embodiments, depth D1 is not so large so as to cause text printed on a printed paper item 40 from being covered by members 50 or 52.

A spring member 60 is also provided in the slot 30. The spring member is held in place by a flange 58 formed as part of member 50. The spring member 60 is curved and is positioned about stop member 54 as shown. A curved portion 61 is formed in spring member 60 within slot 30. When a printed paper item 40 is slid in to slot 30, the curved portion 61 presses down on a printed paper item 40 to retain a printed paper item 40 in slot 30. The spring constant associated with curved portion 61 is not so great that the printed paper item 40 cannot be readily inserted into slot 30 but is large enough in accordance with various embodiments to push down on printed paper item 40 to retain the printed paper item 40 in the slot and help to retain the printed paper item 40 in a rigid or semi-rigid orientation to be imaged.

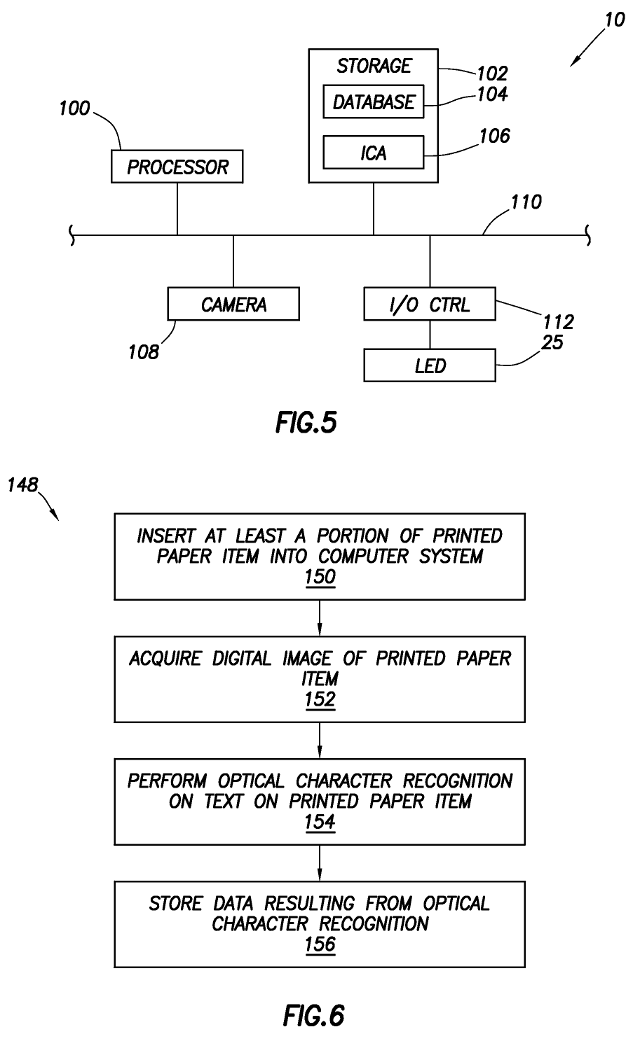

FIG. 5 shows a block diagram of system 10 in accordance with various embodiments. As shown, system 10 comprises a processor 100 coupled to stored 102, camera 108 and an input/output (I/O) controller 112 via a bus structure 110. The indicator 25 couples to and is driven by the IO controller 112 under control or processor 100. The processor 100 sends command and control signals to camera 108 to have the camera 108 acquire images and provide the output images to the storage 102 for storage therein.

Storage 102 comprises volatile memory (e.g., random access memory), non-volatile storage (e.g., hard disk drive, flash memory, read-only memory, etc.) and combinations thereof. As shown in FIG. 5, storage 102 comprises a database 104 and an image capture application 106. The database 104 is used to store the resulting data from the optical character recognition process. The image capture application comprises code executable by processor 100 to perform some or all of the functionality herein. For example, the image capture application prompts the user to lower the display lid 14, causes the camera 108 to perform an auto-focus process, eliminates indicator 25 when auto-focus has been achieved, and performs optical character recognition on the resulting image. The user may deactivate (i.e., terminate) the ICA 106 upon finishing the image capturing process and rotating the display lid 14 to opened position in which the user can view the display 16.

FIG. 6 shows a method 148 in accordance with various embodiments of the invention, at 150, method 148 comprises inserting at least a portion of the printed paper item 40 into the system 10. At 152, the method 148 further comprises acquiring a digital image of the printed paper item 40. At 154, method 148 comprises performing optical character recognition on text on the printed paper item 40. At 156, the method further comprises storing the data resulting from the optical character recognition in database 104.

The optical character recognition process functions regardless of the orientation of the lettering on the printed paper item 40. Thus, in some embodiments, the printed paper item 40 is inserted into slot 30 such that the text is “upside down” in viewed by a user seated in front of system 10. In other embodiments, the printed paper item is inserted into slot 30 such that the text is “right-side up” when viewed from the vantage point of a user seated in front of system 10.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a camera;
a housing comprising a slot, said slot adapted to receive at least a portion of a printed paper item, an image of which is acquired by said camera; and
logic that performs optical character recognition on said image.

2. The system of claim 1 wherein said system comprises a portable computer, and said housing contains a keyboard.

3. The system of claim 1 wherein said system comprises a portable computer comprising a hinged display lid and said camera is mounted in said hinged display lid.

4. The system of claim 3 wherein said image is acquired when said hinged display lid is partially lowered.

5. The system of claim 3 wherein said image is acquired when said hinged display lid is lowered toward a keyboard at least to a point at which a display provided in said hinged display housing cannot be viewed by a user of said system.

6. The system of claim 1 further comprising a spring retaining member in said slot, said spring retaining member adapted to receive an end of said printed paper item.

7. The system of claim 1 wherein said slot comprises a depth such that only a portion of said printed paper item resides in said slot and the remaining portion of said printed paper item is outside said slot and facing said camera.

8. The system of claim 1 further comprising a database wherein output from said optical character recognition on said image is stored in said database.

9. The system of claim 1 further comprising an indicator that is activated when said printed paper item is in focus.

10. A method, comprising:
inserting at least a portion of a printed paper item into a computer;
acquiring a digital image of the printed paper item with a camera provided in the computer; and
performing an optical character recognition on text on said printed paper item.

11. The method of claim 10 wherein a display lid of said computer comprises the camera and said method further comprises lowering the display lid to acquire said digital image.

12. The method of claim 10 wherein a hinged display lid of said computer comprises a camera and said method further comprises lowering the display lid until auto-focus is detected.

13. The method of claim 12 further comprising indicating to a person that auto-focus is detected.

14. The method of claim 10 wherein acquiring the digital image is performed automatically upon determining that the printed paper item is in focus.

15. The method of claim 10 further comprising storing output data from said optical character recognition in said computer.

16. The method of claim 10 further comprising decreasing a focal length of a camera provided in the computer upon detecting that a user desires to have optical character recognition performed on the text on said printed paper item.

17. A computer-readable medium comprising software that, when executed by a processor, causes the processor to:
acquire a digital image of a printed paper item at least partially inserted into a housing containing said processor; and
perform an optical character recognition on text on said printed paper item.

18. The computer-readable medium of claim 17 wherein said software also causes said processor to indicate to a user when a display lid comprising a camera has been lowered sufficiently to permit said camera to achieve auto-focus on said printed paper item.

19. The computer-readable medium of claim 17 wherein said software also causes said processor to store output data from said optical character recognition.

20. The computer-readable medium of claim 17 wherein said printed paper item comprises a business card and said software causes said processor to store in a database a name printed on said business card and determined from said optical character recognition.
